(19) United States
(12) Patent Application Publication
(10) Pub. No.: US 2015/0262186 A1
(43) Pub. Date: Sep. 17, 2015

(54) Pricing Content Items in Groups

(71) Applicant: Google Inc., Mountain View, CA (US)

(72) Inventors: Anand Murugappan, Milpitas, CA (US); Aranyak Mehta, Mountain View, CA (US)

(73) Assignee: Google Inc., Mountain View, CA (US)

(21) Appl. No.: 14/204,348

(22) Filed: Mar. 11, 2014

(51) Int. Cl. G06Q 30/00

(52) U.S. Cl. CPC G06Q 30/00

(57) ABSTRACT

Methods, systems, and apparatus include computer programs encoded on a computer-readable storage medium, including a method for providing content. A request for content for publication is received. Content items are identified responsive to the request, including identifying groups of content items. An auction is conducted to identify content to provide, including identifying at least first and second groups of content items. A price to charge sponsors associated with each content item in each group is determined. For each content item in a group, a first bounding price is determined that is a second price auction value, a second bounding price is determined reflecting a value to be maintained for the content item to keep the respective group in a same position in a group ranking, and a final price is determined equal to the greater of the first and second bounding prices. A sponsor is charged the determined final price.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can be provided to a user device such as a personal computer (PC), a smartphone, a laptop computer, a tablet computer, or some other user device. Content can be provided in several different ways depending on the type of content, its source, and its relevance to the user.

### SUMMARY

In general, one innovative aspect of the subject matter described in this specification can be implemented in methods that include a computer-implemented method for providing content. The method includes receiving a request for content for publication on a resource. The method further includes identifying, using one or more processors, a plurality of content items that are responsive to the request, including identifying a plurality of groups of content items. The method further includes conducting an auction to identify content to provide responsive to the request, including identifying at least a first group and a second group of content items wherein each group includes plural content items. The method further includes determining a price to charge sponsors associated with each content item in each group. The method further includes, for each content item in a group, determining a first bounding price that is a second price auction value for a respective individual content item in a respective group. The method further includes, for each content item in a group, determining a second bounding price that is a price that reflects a value that must be maintained for the respective individual content item in order to keep the respective group in a same position in a ranking of the groups. The method further includes, for each content item in a group, determining a final price that is equal to a greater of the first and second bounding prices. The method further includes charging a sponsor associated with a respective content item the determined final price. These and other implementations can each optionally include one or more of the following features. The method can further include ranking individual content items in each group. Ranking can include ranking based on one or more performance metrics. The method can further include ranking each group to create a list of top-ranked groups, including ranking each group based on a slate utility, wherein the slate utility is measured based on a weighted sum of the utility associated with each individual content item in a respective group. The slate utility can be a weighted sum of utility for a given content item. The weighted sum of utility can be a weighted sum of a bid times expected click-through rate. The method can further include determining a number of content items to be included in each group based at least in part on an amount of space on the resource that is allocated to present responsive content items. The method can further include determining a number of groups to be presented on the resource responsive to the request based at least in part on an amount of space on the resource that is allocated to present responsive content items. The method can further include determining that a single content sponsor is associated with two content items in a same group, and determining a second bounding price can include determining a second bounding price for a first content item associated with the single content sponsor as equal to an allocated portion of a sum of values associated with each content item in the group that are associated with the single content sponsor. The allocation can be selected from the group comprising a weighted allocation based on one or more criteria or an equal allocation. The weighting can be based on a ranking in the group. The value can be a value used in determining how much to price a respective content item in order for a group associated with the content item to be maintained in a current position in a ranking of groups of content items. The method can further include determining that a single content sponsor is associated with two different content items that are included in two different groups, and wherein determining a second bounding price includes determining a second bounding price for a first content item associated with the single content sponsor using a second price bid associated with a second content item associated with the single content sponsor. The value can be a bid amount.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a request for content for publication on a resource; identify a plurality of content items that are responsive to the request, including identifying a plurality of groups of content items; conduct an auction to identify content to provide responsive to the request, including identifying at least a first group and a second group of content items wherein each group includes plural content items; determine a price to charge sponsors associated with each content item in each group, including for each content item in a group: determine a first bounding price that is a second price auction value for a respective individual content item in a respective group, determine a second bounding price that is a price that reflects a value that must be maintained for the respective individual content item in order to keep the respective group in a same position in a ranking of the groups, and determine a final price that is equal to a greater of the first and second bounding prices; and charge a sponsor associated with a respective content item the determined final price.

These and other implementations can each optionally include one or more of the following features. The instructions can further include instructions to determine that a single content sponsor is associated with two content items in a same group, and determining a second bounding price can include determining a second bounding price for a first content item associated with the single content sponsor as equal to an allocated portion of a sum of values associated with each content item in the group that are associated with the single content sponsor. The instructions can further include instructions to determine that a single content sponsor is associated with two different content items that are included in two different groups, and determining a second bounding price can include determining a second bounding price for a first content item associated with the single content sponsor using a second price bid associated with a second content item associated with the single content sponsor.

In general, another innovative aspect of the subject matter described in this specification can be implemented in systems, including a system comprising one or more processors and one or more memory elements including instructions. The instructions, when executed, cause the one or more processors to: receive a request for content for publication on a resource; identify a plurality of content items that are responsive to the request, including identifying a plurality of groups of content items; conduct an auction to identify content to provide responsive to the request, including identifying at least a first group and a second group of content items wherein each group includes plural content items; determine a price to charge sponsors associated with each content item in each group, including for each content item in a group: determine a first bounding price that is a second price auction value for a respective individual content item in a respective group, determine a second bounding price that is a price that reflects a value that must be maintained for the respective individual content item in order to keep the respective group in a same position in a ranking of the groups, and determine a final price that is equal to a greater of the first and second bounding prices; and charge a sponsor associated with a respective content item the determined final price.

These and other implementations can each optionally include one or more of the following features. The instructions can further include instructions to determine that a single content sponsor is associated with two content items in a same group, and determining a second bounding price can include determining a second bounding price for a first content item associated with the single content sponsor as equal to an allocated portion of a sum of values associated with each content item in the group that are associated with the single content sponsor. The instructions can further include instructions to determine that a single content sponsor is associated with two different content items that are included in two different groups, and determining a second bounding price can include determining a second bounding price for a first content item associated with the single content sponsor using a second price bid associated with a second content item associated with the single content sponsor.

Particular implementations may realize none, one or more of the following advantages. Content items can be grouped and priced according to a ranking and a position of a content item in a group and the group's ranking among other groups. A content sponsor's bid can be used to maintain a corresponding content item's position when presented in a user interface. Content sponsors can bid higher to have their content items appear in more prominent locations within groups.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content

FIG. 2 is a block diagram of an example of a system for grouping content items.

FIG. 3 is a block diagram of an example system for selecting content items in an auction using grouped items.

FIG. 4 shows examples of final re-priced costs for items in groups leading to a re-ranking of groups.

FIG. 5 shows examples of individual prices that are adjusted in their respective groups.

FIG. 6 shows example groups of content items that are ordered and re-priced by slate utility.

FIG. 7 is a flowchart of an example process for grouping and pricing content items.

FIG. 8 is a flowchart of an example process for grouping and pricing content items.

FIG. 9 is a block diagram of an example computer system that can be used to implement the methods, systems and processes described in this disclosure.

Like reference numbers and designations in the various drawings indicate like elements.

### DETAILED DESCRIPTION

Systems, methods, computer program products and mechanisms are described for providing content items that are grouped in various ways for presentation responsive to received requests, and further priced based at least in part on the grouping. For example, in response to a request for content for publication on a resource, groups of content items can be identified. An auction can be conducted to identify at least a first group and a second group for presentation. In some implementations, a price can be determined to charge sponsors associated with each of the content items in each group, including determining a first bounding price, a second bounding price, and a final price. For example, the first bounding price can be a second price auction value for a respective individual content item in a respective group. The second bounding price, for example, can be a price that reflects a value that must be maintained for the respective individual content item in order to keep the respective group in a same position in a ranking of the groups. The final price, for example, can be equal to the greater of the first and second bounding prices. A sponsor associated with a respective content item can be charged the determined final price.

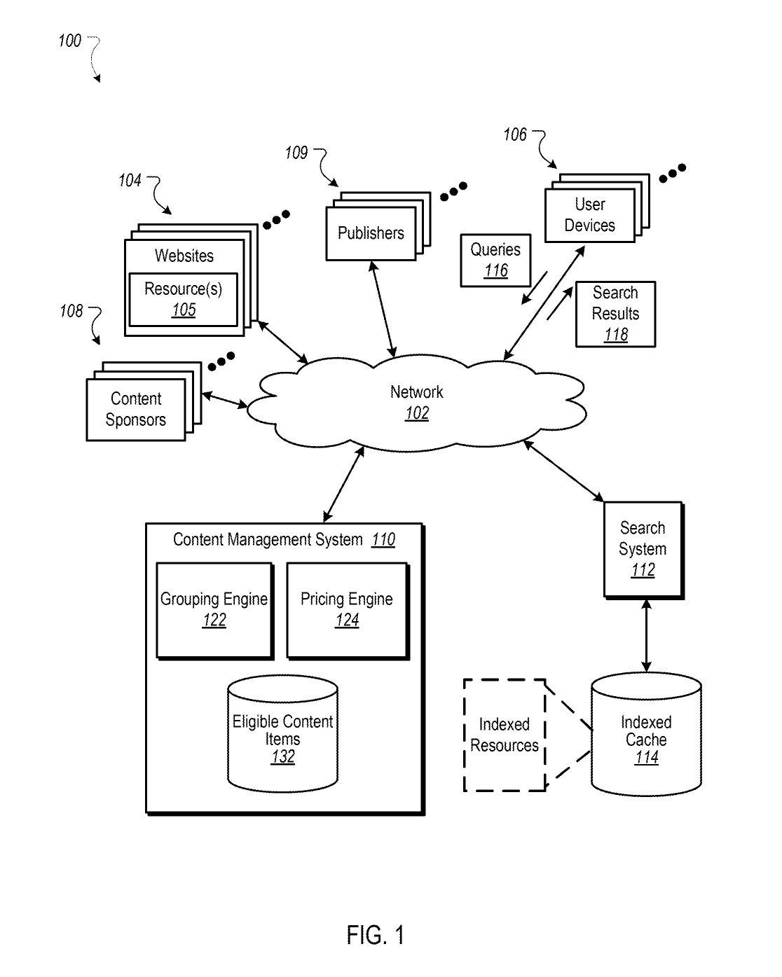

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The content management system 110 can include plural engines. A grouping engine 122, for example, can group content items. For example, the grouping engine 122 can identify at least a first group and a second group of content items from among plural groups, wherein each group includes plural content items. The content items that are grouped, for example, can be identified when conducting an auction to identify content to provide responsive a received request for content for publication on a resource.

A pricing engine 124, for example, can determine prices to charge sponsors associated with each content item in each group. For example, for each content item in a group, the pricing engine 124 can determine a first bounding price that is a second price auction value for a respective individual content item in a respective group. The pricing engine 124 can also determine a second bounding price as a price that reflects a value that must be maintained for the respective individual content item in order to keep the respective group in a same position in a ranking of the groups. The pricing engine 124 can further determine a final price that is equal to the greater of the first and second bounding prices. The pricing engine 124 can charge a content sponsor associated with a respective content item the determined final price.

The environment 100 can include plural data stores, which can be stored locally by the content management system 110, stored somewhere else and accessible using the network 102, generated as needed from various data sources, or some combination. A data store of eligible content items 132, for example, can include content items (e.g., advertisements) that can be selected by the content management system 110 in response to a request, e.g., a request for content for publication on a resource. As an example, the request can be associated with a search query associated with furniture. In response to the request, the content management system 110 can identify eligible content items 132 responsive to the search query, e.g., content items (such as advertisements or product listings) associated with chairs, tables, sofas and other furniture.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as republishing or sharing the content item. Other actions that constitute a conversion can also be used.

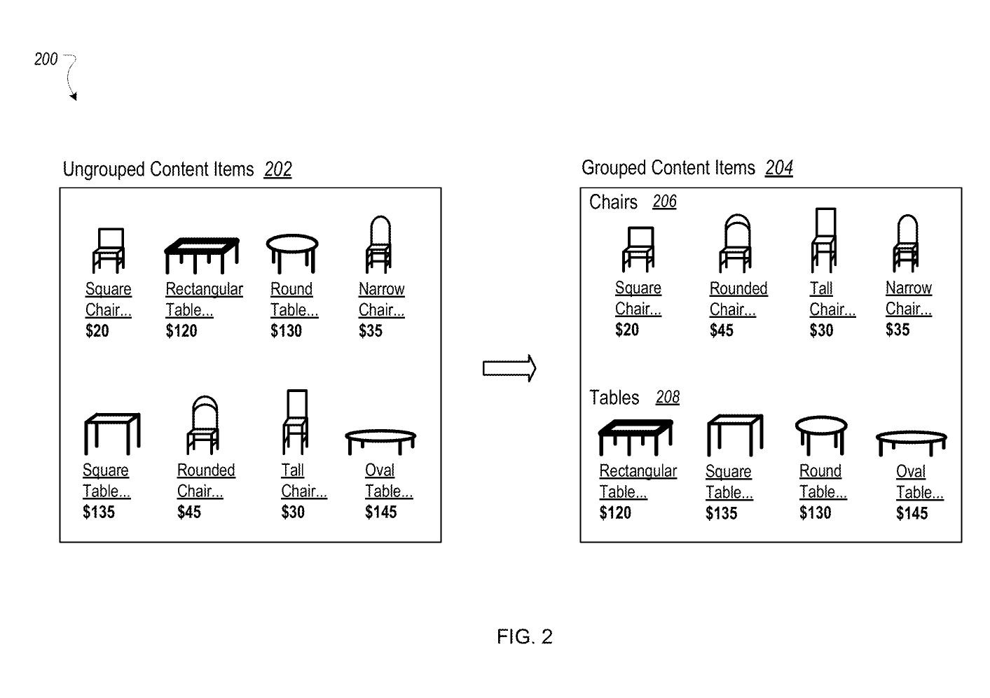

FIG. 2 is a block diagram of an example of a system 200 for grouping content items. For example, in response to a user query for “furniture” (e.g., entered on a web page or in a browser), ungrouped content items 202 can be identified in response to the query. The ungrouped content items 202, for example, can include randomly-arranged content items associated with various types of furniture (e.g., tables and chairs) matching the query. The tables and chairs, for example, can be offered by different content sponsors (e.g., merchants). In conventional systems, a second price per position auction or some other auction can be used, e.g., on a per-item basis and priced without regard to grouping that can occur using the items.

In some implementations, the ungrouped content items 202 can be presented as grouped content items 204. For example, chair-related content items 206 can include chairs, and table-related content items 208 can include tables. Grouping content items can be useful to a user, e.g., if more than two different groups (e.g., beyond just tables and chairs) are included. While FIG. 2 shows four of each item in each of two groups, there can be any number of groups, and the items in each group can vary or can be the same and can number from one or more items in a respective group. Grouping of content items can be based on one or more criteria as described in further detail below. For example, grouping can be by product type, manufacturer, or by other criteria. The number of groups that are presented and the number of content items in each group can depend on the available space for presenting content items responsive to the received request.

In some implementations, bids and prices charged for individual content items in the grouped content items 204 can depend on grouping, as will be explained in more detail below. For example, bids and prices charged may depend on various factors, such as individual bids, bids affected by the group, slate utilities, and/or whether or not a particular merchant has content items in the same group and/or in different groups. Other factors for selecting groups and pricing content items in groups can be used.

In some implementations, groups can be determined and/or divided in different ways. For example, groups can be based on one or more of item type (e.g., chairs, tables, sofas), category, sub-category, price, size, color, brand, availability, shipping costs, and/or other factors. Further, a decision to group or not to group items can depend on a determination of whether or not distinct groups can be determined, e.g., two or more groups each having at least a threshold number of items in a group, or in other ways.

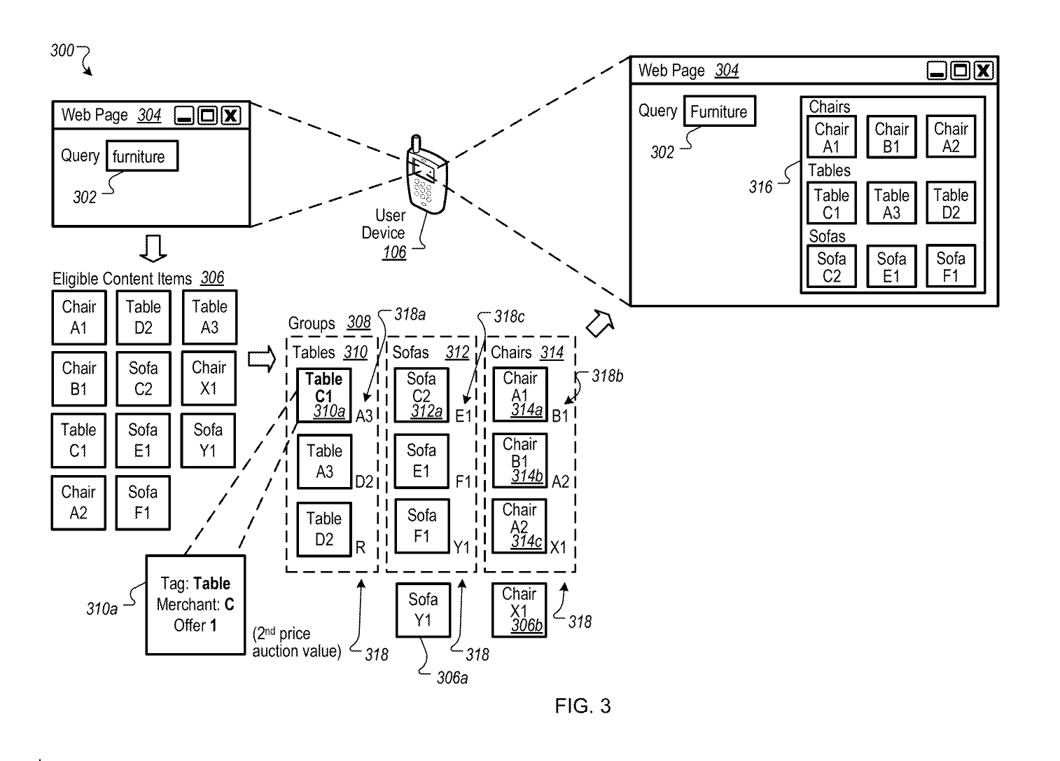

FIG. 3 is a block diagram of an example system 300 for selecting content items in an auction using grouped items. For example, the content management system 110 can receive a request for content for publication on a resource. The request, for example, can be initiated by a user of a device 106 entering a query 302 (e.g., “furniture”) on a web page 304. Other ways for providing a query or initiating a request can be used, such as on a product-selling web page. In response to the query 302, for example, the content management system 110 can identify a plurality of content items that are responsive to the request (e.g., eligible content items 306 that are selected based, at least in part, on the query 302). The grouping engine 122, for example, can group the identified eligible content items 306 to identify a plurality of groups of content items, e.g., the groups 308. The pricing engine 124, for example, can be used to conduct an auction to identify content to provide responsive to the request, including identifying at least a first group (e.g., a chairs group 314) and a second group of content items (e.g., a tables group 310). Each group can include plural content items (e.g., chairs and tables, respectively).

As shown in FIG. 3, items in the groups 310-314 can be labeled using a shortened notation. For example, for a table item 310a (e.g., “Table D2”), the type of item or tag is “Table,” the merchant is “C,” and the item offer is 1. The same merchant C can have other offers, e.g., a sofa item 312a (e.g., Sofa C2) that has the offer number 2. Other items offered by the same merchant would include the merchant identification of C and a different offer number.

The pricing engine 124 can determine a price to charge sponsors associated with each content item in each group when a group is determined to be presented. For example, for each content item in a group, the pricing engine 124 can determine a first bounding price that is a second price auction value for a respective individual content item in a respective group. For example, for the “A1” chair 314a, the second price auction value can be a value that exceeds a second place bid (e.g., “B1” chair 314b) by a threshold amount. For example, if the bid for the “A1” chair 314a was $5, and the next highest bid was $3, then the second price auction value for the “A1” chair 314a can be slightly more than $3 (e.g. $3.01). In the example described, the bids are not adjusted. In some implementations, bids may be adjusted by a quality score wherein the quality score can be based on one or more signals. Examples of signals can include estimated click-through rate, other performance measures, relevance, or other quality metrics related to the content that is proposed to be presented. In these implementations, the second price auction value is again determined to be the value that maintains the relative position of given item in the group (i.e., the bid, given the quality score, that maintains a respective item in its respective position in the group).

The pricing engine 124 can also determine a second bounding price that is a price that reflects a value that must be maintained for the respective individual content item in order to keep the respective group in a same position in a ranking of the groups. Group ranking can be based, for example, on a slate utility measure that is a sum of the utility associated with each element in the group. Other ways of ranking the groups are possible. For example, the chairs group 314 can be the highest-ranked group among the groups 310-314. This highest rank can occur, for example, if the slate utility for the chairs 314 is higher than the slate utility for the tables group 310 and the sofa group 312.

Using the second price auction value and the second bounding price for the “A1” chair 314a, the pricing engine 124 can determine a final price (e.g., “B1” price 318b). In some implementations, the final price is equal to the greater of the first and second bounding prices, such as:

final price=max(second price auction value,second bounding price) (1)

Prices 318 can be calculated in the same way for the other items in a respective group and for items in the other groups, with each price being a function of a bid of the item (as shown in FIG. 3). Detailed examples of how these prices are calculated are provided below. In some implementations, the ranking of particular items in a group can be based on more than initial bids for each content item. For example, the ranking can be based on a second price per position auction, the number of items that can be displayed in a content item slot 316 on the web page 304, and whether particular content sponsors 108 (e.g., merchants) are associated with more than one content item in the same group or in different group, as will be discussed below. As a result, a given price 318 (e.g., denoted as “A3” for “C1” table 310a) can have a value that causes the item to be included in the group as well as influences whether the group (e.g., tables group 310) is a highest-ranking group.

The pricing engine 124 can charge a sponsor associated with a respective content item the determined final price. For example, depending on a final price that is determined for the “A1” chair 314a, the associated content sponsor (e.g., sponsor “A”) can be charged that final price for including the item 1 in the first position of the chairs group 314.

As shown in FIG. 3, not all eligible content items 306 are included in the groups 310-314. For example, a “Yl” sofa eligible content item 306a is not included in the sofas group 312. This can occur, for example, because after the eligible content items 306 are grouped into groups, a per-position auction can be initiated which determines each content item's rank or position in the group.

In some implementations, the number of content items to be included in each group can be determined based, at least in part, on an amount of space on the resource that is allocated to present responsive content items. For example, three items each are determined to be included in the groups 310-314 because nine items (e.g., three groups of three) will fit in the content item slot 316.

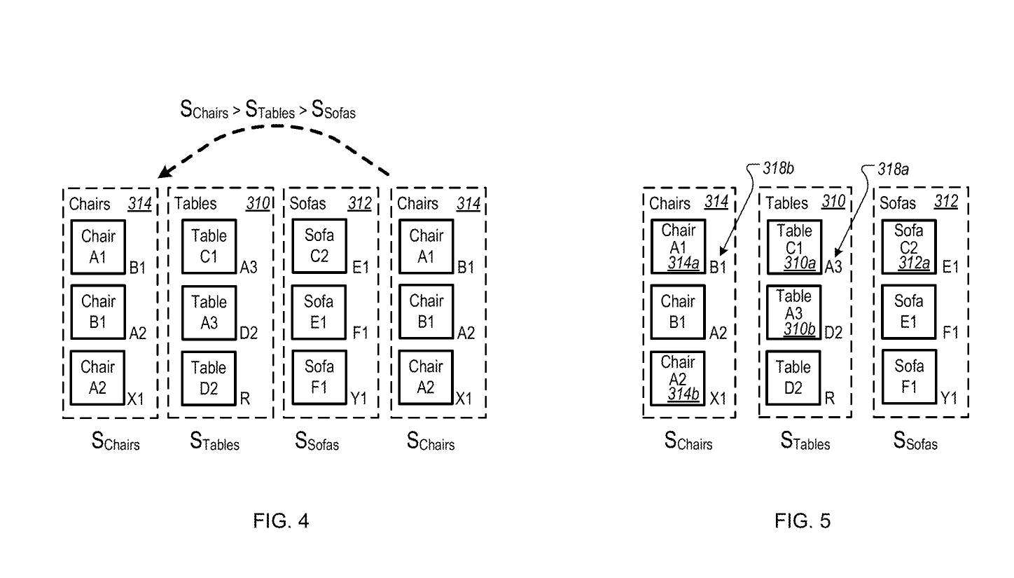

FIG. 4 shows examples of final re-priced costs for items in groups leading to a re-ranking of groups. For example, the pricing engine 124 can rank the groups 310-314, e.g., including ranking other groups (e.g., lamps not shown in FIG. 4) lower than the groups 310-314. The ranking, for example, can create a list of top-ranked groups (e.g., the groups 310-314). Ranking each group can be based on a slate utility. For example, the slate utility for the chairs group 314, the tables group 310, and the sofas group 312 can be S_{Chairs}, S_{Tables}, and S_{Sofas}, respectively. Each slate utility, for example, can be measured based on a weighted sum of the utility associated with each individual content item in a respective group. As shown in FIG. 4, for example, the chairs group 314 can be the top-ranked group (among the groups 310-314) because the chairs group 314 has the greatest slate utility, e.g., given by:

S_{Chairs}>S_{Tables}>S_{Sofas} (2)

For example, as shown in Equation 2, group utility scores can be computed, from which the groups can be ordered, e.g., chairs, then tables, then sofas. Further, within each group, weights can be assigned to items within the group, and the weights can be used to determine a value of the slate utility associated with the group. For example, the slate utility S_{Tables} for the tables group 310 can be given by the weighted sum of the utility associated with each individual content item in the group, such as:

S_{Tables}=w₁C1+w₂A3+w₃D2 (3)

where w₁, w₂, and w₃ are weights for table-related content items C1, A3 and D2, respectively.

FIG. 5 shows examples of individual prices that are adjusted in their respective groups. For example, the price for an item can be adjusted based on one or more factors, such as a reserve slate utility. Details for examples of adjusting individual prices within a group are provided below.

In some implementations, an individual item's price can be adjusted against a reserve slate utility (e.g., S_{R}). The reserve slate utility, for example, can be a utility for which all selected slates (e.g., groups) must match or exceed, e.g. in order to be selected in response to a request. It can be determined, for example, that the slate utility for the sofas group 312 is greater than the reserve slate utility (e.g., S_{R}), such that, for example:

S_{Sofas}>S_{R} (4)

Using the inequality of Equation 4 in combination with Equation 3, for example, can provide, with respect to the individual items in the sofas group 312 and associated weights:

w₁C2+w₂E1+w₃F1>S_{R} (5)

thus, solving for E1:

E1>(S_{R}−w₁C2−w₃F1)/w₂ (6)

In some implementations, the pricing (or the cost) of E1, can be:

Cost_{E1}=(S_{R}−w₁C2−w₃F1)/w₂ (7)

The final cost, (e.g., the “E1” price 318c) can be computed as the greater of the first and second bounding prices (e.g., as also done in Equation 1), such as:

FinalCost_{E1}=max(Cost_{E1},F1) (8)

In some implementations, special pricing can be determined in situations when the same content sponsor (or same bidding agent) is associated with content items in different groups, e.g., two slates. For example, consider the “C1” table 310a and the “C2” sofa 312a, both sharing the same content sponsor C. The pricing engine 124, for example, can price C1 and C2 against each other, a situation in which the content sponsor C would want to lower the price of C2. In some implementations, a second price discounted value can be used for C2, such as C#2. Then, the pricing can include a cost of C1, e.g., given by:

Cost_{C1}=(S_{Sofas}−w₁C2+w₁C#2−w₂A3−w₃D2)/w₁ (9)

The final cost for the “C1” table 310a, (e.g., the “A3” price 318a) can be computed as the greater of the first and second bounding prices (e.g., as also done in Equation 1):

FinalCost_{C1}=max(Cost_{C1},A3) (10)

In some implementations, pricing can be determined in situations when the same content sponsor (or same bidding agent) is associated with content items in the same group, e.g., the same slate. For example, consider the “A1” chair 314a and the “A2” chair 314b, both sharing the same content sponsor A. In this example, increasing A2 would mean paying less for A1 without paying more for A2. In some implementations, the pricing engine 124 can instead price A1 and A2 together and distribute the costs between them. In some implementations, a second price discounted value (e.g., A#3) can be used for the “A3” table 310b, in the tables group 310. Then the pricing can include cost of A1 and A2, e.g., given by:

w₁A1+w₃A2>(S_{Tables}−w₁A3+w₁A#3−w₂B1) (11)

In some implementations, other ways can be used for rank the content items within a group. In some implementations, within each group, an item level utility can be used, such as an eCPM or long term value (LTV), and the content items can be sorted based on their utilities. For example, eCPM (expected cost per mille (1000) impressions) can be computed as pCTR*bid, where pCTR is a click-through rate probability, as computed by conventional systems. LTVs can take into account aspects beyond short-term revenue (represented by eCPM) such as a cost of showing content items (e.g., advertisements) to users, a cost of a bad click, and/or other aspects. Item utility for the jth item in a group i, for example can be represented as eCPM(Gᵢⱼ), and can also be extended to LTVs as well.

In some implementations, pricing can occur so as to identify a minimum price that a content sponsor needs to bid to retain a position in a group. This can be done through a standard generalized second price mechanism. For example:

eCPM(G_{ij′})=pCTR(G_{ij′})*Bid(G_{ij′}) (12)

and:

CPC(Gᵢⱼ)=max(eCPM(G_{ij′}),Rⱼ/pCTR(Gᵢⱼ)) (13)

where G_{ij′} represents the losing offer for position j, and Rⱼ is the reserve score for the item group j.

In some implementations, utility for item-group Gᵢ can be computed as:

eCPM(Gᵢ)=pCTR(Gᵢ)*(Σⱼ(wⱼ*eCPM(Gᵢⱼ)) (14)

which can represent a probability that each item will be clicked/noticed multiplied by a weighted sum of individual item utilities. This can be used to order the item-groups based on the slate utility.

In some implementations, pricing can be used so that a content sponsor will generally pay a minimum amount to keep his position among the selected content items, and that the content sponsor is not able to get the same clicks at a lower price. Further, content sponsors can be prevented from getting more clicks at the same price. To achieve this, for example, CPC for the item can be computed as:

CPCitem=(eCPM′LosingGroup−eCPM′Group)/pCTRitem (15)

where eCPM′LosingGroup is the weighted sum of the individual item eCPMs within the group (with a distinction that if it is for the same merchant who is being priced we use the minimum bid), and eCPM′Group is the weighted sum of the individual items other than the terms in question.

In some implementations, when there are multiple offers from the same content sponsor within the slate, offers from the same content sponsor can be priced as one group, and the cost can be distributed across the items:

YM=(eCPM′LosingGroup−eCPM′Group)/(ΣMi(pCTR_{—}Mi)) (16)

In this equation, M is content sponsor (or merchant) whose offers within the group are computed using the minimum CPC, eCPM′LosingGroup is the eCPM of the losing group (with the offers from merchant M using the min-CPC and the rest of the offers using CPC), eCPM′Group is the winning group for which the CPCs are being computed, and ΣMi(pCTR_Mi) is the total pCTR for all offers from merchant M within the group.

In some implementations, YM can then be distributed as evenly as possible among the various offers, e.g., according to the following algorithm/formula:

```
procedure distribute_cost_across_merchant:
  reminder_size = total number of winning offers from merchant
  ‘M’ in Group
  Y_reminder = Y_M
  for each offer i from merchant ‘M’ in the Group ordered ascending
  by their max-cpc:
    Y_share = Y_reminder / reminder_size
    if (max-cpc_i > Y_share):
      min-cpc_i = Y_share
    else:
      min-cpc_i = max-cpc_i
    Y_reminder = Y_reminder − min-cpc_i
    reminder_size = reminder_size −1
done procedure
```

In some implementations, other distribution mechanisms can be used which would spread the incremental cost more evenly across the other offers, e.g., by taking into account user interface norms for displaying items in groups.

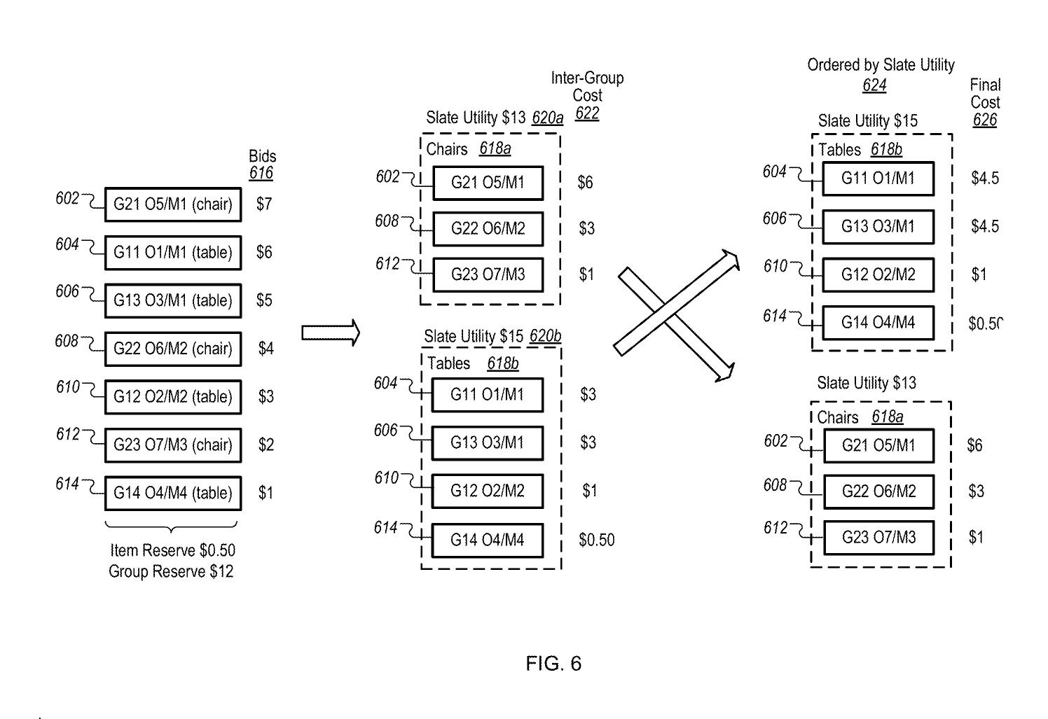

FIG. 6 shows example groups of content items that are ordered and re-priced by slate utility. For example, content items 602-614, related to chairs and tables, can have individual bids. The grouping engine 122, for example, can group the content items 602-614 into a chairs group 618a and a tables group 618b. The pricing engine 124, for example, can determine slate utilities 620a and 620b for the groups 618a and 618b, respectively. In some implementations, the pricing engine 124, for example, can determine inter-group costs 622 that can be proportional to the bids 616 for the corresponding content items and for which the sums of the inter-group costs 622 can sum to totals that are proportional to the slate utilities 620a and 620b. Because the slate utility 620b is higher than the slate utility 620a, the tables group 618b can be ranked higher than the chairs group 618a, as indicated by a new order 624. In some implementations, the pricing engine 124, for example, can determine final costs 626 so that the total (e.g., $10.50) of the final costs 626 for the content items in the tables group 618b exceeds the total (e.g., $10) of the final costs 626 for the content items in the chairs group 618a.

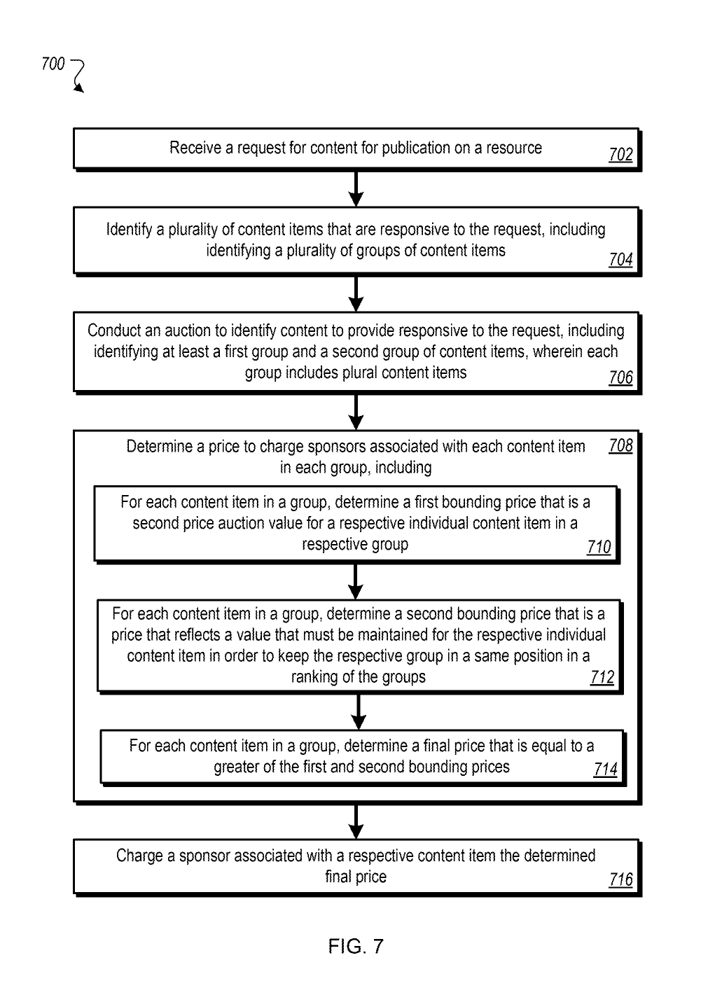

FIG. 7 is a flowchart of an example process 700 for grouping and pricing content items. In some implementations, the content management system 110 can perform stages of the process 700 using instructions that are executed by one or more processors. FIGS. 1-6 are used to provide example structures for performing the stages of the process 700.

A request is received for content for publication on a resource (702). Referring to FIG. 3, for example, a request for content can result when the user of the device 106 enters the query 302 (e.g., “furniture”) on the web page 304.

A plurality of content items that are responsive to the request are identified, including identifying a plurality of groups of content items (704). For example, the content management system 110 can identify the eligible content items 306, from which the grouping engine 122 can identify the groups 308 that can include groups for chairs, tables, sofas, and other groups 308 not shown. Content items included in the groups 308 can be identified from the eligible content items 132.

An auction is conducted to identify content to provide responsive to the request, including identifying at least a first group and a second group of content items, wherein each group includes plural content items (706). As an example, the pricing engine 124 can identify the groups 310, 312 and 314, related to tables, sofas and chairs. The groups 310-314 can be identified, for example, because the corresponding slates have a utility measure (e.g., based on their bids) that is greater than for other groups not shown in FIG. 3.

In some implementations, the process 700 can further include ranking individual content items in each group. For example, the pricing engine 124 can rank the individual items in each of the groups 310-314, including the items 314a-314c in the chairs group 314. In some implementations, the ranking can include ranking based on one or more performance metrics. For example, the ranking of individual content items in a group can be based, at least in part, on a historical likelihood that a user would interact with a content item in a particular position, e.g., the first content item in a group, or the content item closest to a visual display.

In some implementations, the process 700 can further include ranking each group to create a list of top-ranked groups, including ranking each group based on a slate utility, wherein the slate utility is measured based on a weighted sum of the utility associated with each individual content item in a respective group. Referring to FIG. 4, for example, the chairs group 314 is ranked higher than the other groups 310 and 312 because the chairs group 314 has the greatest slate utility S_{Chairs} in Equation 2.

In some implementations, the slate utility can be a weighted sum of utility for a given content item. For example, the weighted sum of utility can be a weighted sum of a bid times expected click-through rate. In Equation 3, for example, the slate utility S_{Tables} for the tables group 310 can be given by the weighted sum of the utility associated with each individual content item the group.

In some implementations, the process 700 can further include determining a number of content items to be included in each group based at least in part on an amount of space on the resource that is allocated to present responsive content items. For example, the content management system 110 can determine the number of content items, e.g., three groups of three content items, because of the space available in the content item slot 316.

In some implementations, the process 700 can further include determining a number of groups to be presented on the resource responsive to the request based at least in part on an amount of space on the resource that is allocated to present responsive content items. As an example, the content management system 110 can determine the number of groups 308 (e.g., three) that will fit in space available in the content item slot 316.

A price to charge sponsors associated with each content item in each group is determined (708). For example, the pricing engine 124 can determine prices to charge each of the sponsors of the content items in the groups 310-314.

For each content item in the group, a first bounding price is determined that is a second price auction value for a respective individual content item in a respective group (710). For example, the first bounding price 318b for the content item 314a can be a second price auction value relative to the bid for the next highest bid, e.g., for the content item 314b.

For each content item in the group, a second bounding price is determined that is a price that reflects a value (e.g., a bid amount) that must be maintained for the respective individual content item in order to keep the respective group in a same position in a ranking of the groups (712). Referring to FIG. 6, for example, the pricing engine 124 can determine second bounding prices (e.g., costs 622) for the content items 604, 606, 610 and 614 so that the final costs 626 preserve the tables group 618b as the top-ranked group.

In some implementations, the process 700 can further include determining that a single content sponsor is associated with two content items in a same group, and determining a second bounding price can include determining a second bounding price for a first content item associated with the single content sponsor as equal to an allocated portion of a sum of values associated with each content item in the group that are associated with the single content sponsor. For example, consider a first group A (e.g., a winning slate over a second group B) that includes content items A1, A2 and A3; and the second group B that includes content items B1, B2 and B3. If A1 and A3, for example, are associated with the same content sponsor, then the pricing for A1 and A3, as a sum, can include:

price(A1)+price(A3)=bid(B)−bid(A2) (17)

In this example, second bounding prices for A1 and A3 can be allocated in different ways based on the amount of the original bids for A1 and A3. In some implementations, the allocation (e.g., second bounding prices for A1 and A3) can be a weighted allocation based on one or more criteria, an equal allocation, or some other allocation. For example, the weighted allocation can be proportional to the original bids for A1 and A3. In some implementations, the weighting can be based on a ranking in the group. For example, if A1 is ranked higher in the group than A3, then the weighting for A1 can be greater than for A3. In some implementations, the value can be a value used in determining how much to price a respective content item in order for a group associated with the content item to be maintained in a current position in a ranking of groups of content items. For example, the second bounding prices for A1 can be reduced to a price that still maintains group A over group B. In this example, the remainder of the allocation can be allocated to A3.

In some implementations, the process 700 can further include determining that a single content sponsor is associated with two different content items that are included in two different groups, and determining a second bounding price can include determining a second bounding price for a first content item associated with the single content sponsor using a second price bid associated with a second content item associated with the single content sponsor. For example, consider a first group A (e.g., a winning slate over a second group B) that includes content items A1, A2 and A3; and the second group B that includes content items B1, B2 and B3. If A1 and B2, for example, are associated with the same content sponsor, then the pricing for A1 can include:

price(A1)=bid(B)−bid(B2)+price(B2)−bid(A2)−bid(A3) (18)

In this example, a second price bid can be used in determining the value for B2, and conventional pricing can be used for A2 and other content items that are not associated with the same content sponsor. This can include, for example, using a conventional bid for B2 when determining the price of the slate.

For each content item in the group, a final price is determined that is equal to a greater of the first and second bounding prices (714). For example, final prices, such as final costs 626, can be determined using Equation 10, as described above.

A sponsor associated with a respective content item is charged the determined final price (716). As an example, the content sponsors associated with the content items 602-614 can be charged the final costs 626.

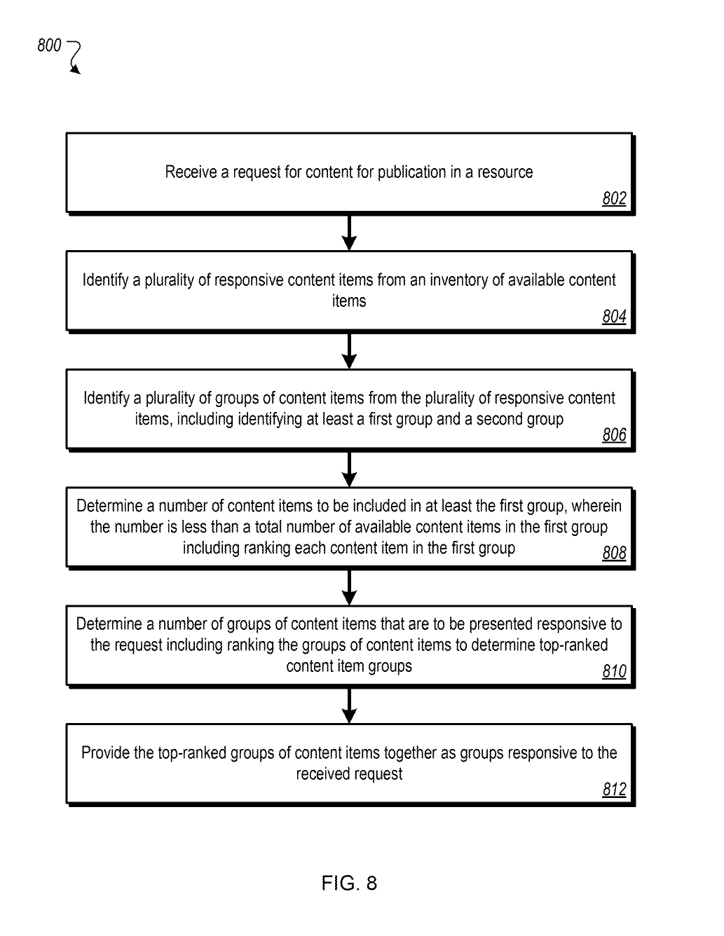

FIG. 8 is a flowchart of an example process 800 for grouping and pricing content items. In some implementations, the content management system 110 can perform stages of the process 800 using instructions that are executed by one or more processors. FIGS. 1-6 are used to provide example structures for performing the stages of the process 800.

A request for content is received for publication in a resource (802). For example, referring to FIG. 3, a request for content can result when the user of the device 106 enters the query 302 (e.g., “furniture”) on the web page 304.

A plurality of responsive content items are identified from an inventory of available content items (804). As an example, the content management system 110 can identify the eligible content items 306, e.g., from the eligible content items 132. The grouping engine 122 can use the eligible content items 306 to identify the groups 308 that can include, e.g., groups for chairs, tables, sofas, and other groups.

A plurality of groups of content items are identified from the plurality of responsive content items, including identifying at least a first group and a second group (806). For example, the grouping engine 122 can identify the groups 310-314.

A number of content items to be included in at least the first group is determined, wherein the number is less than a total number of available content items in the first group, including ranking each content item in the first group (808). For example, in the chairs group 314, the content items 314a-314c can be identified, excluding an “X1” chair content item 306b, which is also a chair.

A number of groups of content items that are to be presented responsive to the request are determined, including ranking the groups of content items to determine top-ranked content item groups (810). For example, the pricing engine 124 can identify the top-ranked groups 310-314, which are ranked higher than other groups that are not shown in FIG. 3.

The top-ranked groups of content items are provided together as groups responsive to the received request (812). For example, content items associated with the groups are provided for presentation in the content item slot 316.

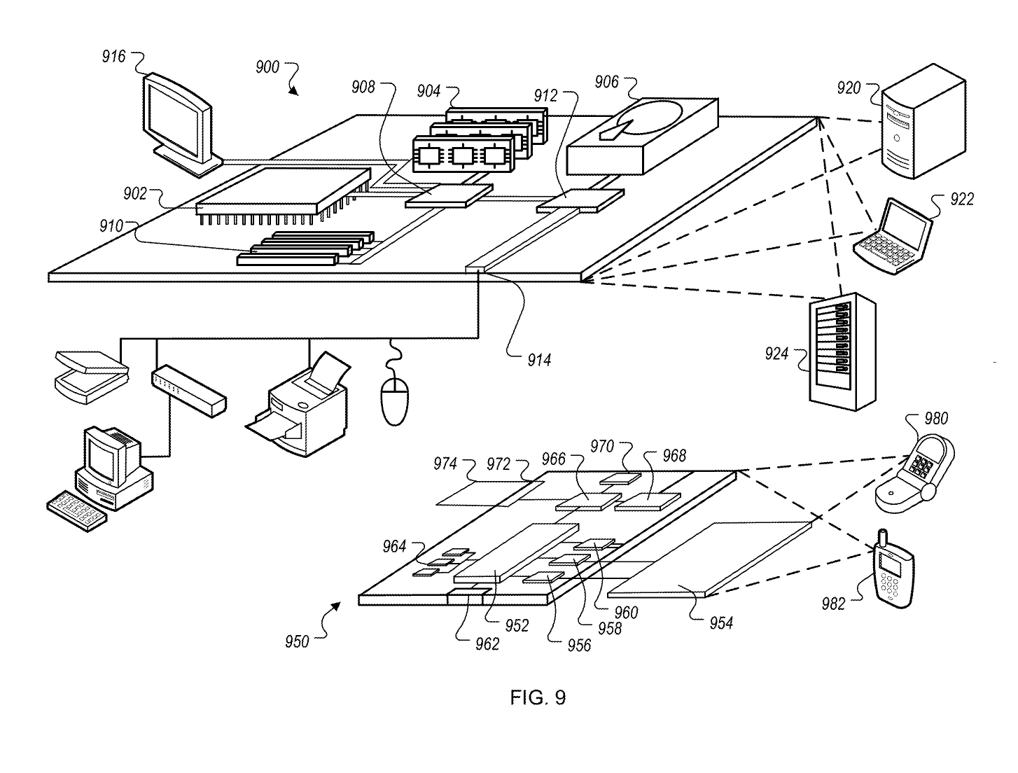

FIG. 9 is a block diagram of example computing devices 900, 950 that may be used to implement the systems and methods described in this document, as either a client or as a server or plurality of servers. Computing device 900 is intended to represent various forms of digital computers, such as laptops, desktops, workstations, personal digital assistants, servers, blade servers, mainframes, and other appropriate computers. Computing device 900 is further intended to represent any other typically non-mobile devices, such as televisions or other electronic devices with one or more processers embedded therein or attached thereto. Computing device 950 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 900 includes a processor 902, memory 904, a storage device 906, a high-speed controller 908 connecting to memory 904 and high-speed expansion ports 910, and a low-speed controller 912 connecting to low-speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed controller 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a computer-readable medium. In one implementation, the memory 904 is a volatile memory unit or units. In another implementation, the memory 904 is a non-volatile memory unit or units.

The storage device 906 is capable of providing mass storage for the computing device 900. In one implementation, the storage device 906 is a computer-readable medium. In various different implementations, the storage device 906 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 904, the storage device 906, or memory on processor 902.

The high-speed controller 908 manages bandwidth-intensive operations for the computing device 900, while the low-speed controller 912 manages lower bandwidth-intensive operations. Such allocation of duties is an example only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed bus 914. The low-speed bus 914 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as computing device 950. Each of such devices may contain one or more of computing devices 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The computing device 950 may also be provided with a storage device, such as a micro-drive or other device, to provide additional storage. Each of the components 950, 952, 964, 954, 966, and 968, are interconnected using various buses, and several of the components may be mounted on a common motherboard or in other manners as appropriate.

The processor 952 can process instructions for execution within the computing device 950, including instructions stored in the memory 964. The processor may also include separate analog and digital processors. The processor may provide, for example, for coordination of the other components of the computing device 950, such as control of user interfaces, applications run by computing device 950, and wireless communication by computing device 950.

Processor 952 may communicate with a user through control interface 958 and display interface 956 coupled to a display 954. The display 954 may be, for example, a TFT LCD display or an OLED display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of computing device 950 with other devices. External interface 962 may provide, for example, for wired communication (e.g., via a docking procedure) or for wireless communication (e.g., via Bluetooth® or other such technologies).

The memory 964 stores information within the computing device 950. In one implementation, the memory 964 is a computer-readable medium. In one implementation, the memory 964 is a volatile memory unit or units. In another implementation, the memory 964 is a non-volatile memory unit or units. Expansion memory 974 may also be provided and connected to computing device 950 through expansion interface 972, which may include, for example, a subscriber identification module (SIM) card interface. Such expansion memory 974 may provide extra storage space for computing device 950, or may also store applications or other information for computing device 950. Specifically, expansion memory 974 may include instructions to carry out or supplement the processes described above, and may include secure information also. Thus, for example, expansion memory 974 may be provide as a security module for computing device 950, and may be programmed with instructions that permit secure use of computing device 950. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952.

Computing device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 968 (e.g., a radio-frequency transceiver). In addition, short-range communication may occur, such as using a Bluetooth®, WiFi, or other such transceiver (not shown). In addition, GPS receiver module 970 may provide additional wireless data to computing device 950, which may be used as appropriate by applications running on computing device 950.

Computing device 950 may also communicate audibly using audio codec 960, which may receive spoken information from a user and convert it to usable digital information. Audio codec 960 may likewise generate audible sound for a user, such as through a speaker, e.g., in a handset of computing device 950. Such sound may include sound from voice telephone calls, may include recorded sound (e.g., voice messages, music files, etc.) and may also include sound generated by applications operating on computing device 950.

The computing device 950 may be implemented in a number of different forms, as shown in the figure. For example, it may be implemented as a cellular telephone 980. It may also be implemented as part of a smartphone 982, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for content for publication on a resource;
identifying, using one or more processors, a plurality of content items that are responsive to the request, including identifying a plurality of groups of content items;
conducting an auction to identify content to provide responsive to the request, including identifying at least a first group and a second group of content items wherein each group includes plural content items;
determining a price to charge sponsors associated with each content item in each group, including for each content item in a group:
determining a first bounding price that is a second price auction value for a respective individual content item in a respective group;
determining a second bounding price that is a price that reflects a value that must be maintained for the respective individual content item in order to keep the respective group in a same position in a ranking of the groups; and
determining a final price that is equal to a greater of the first and second bounding prices; and
charging a sponsor associated with a respective content item the determined final price.

2. The method of claim 1 further comprising ranking individual content items in each group.

3. The method of claim 2 wherein ranking includes ranking based on one or more performance metrics.

4. The method of claim 2 further comprising ranking each group to create a list of top-ranked groups, including ranking each group based on a slate utility, wherein the slate utility is measured based on a weighted sum of the utility associated with each individual content item in a respective group.

5. The method of claim 4 wherein the slate utility is a weighted sum of utility for a given content item.

6. The method of claim 4 wherein the weighted sum of utility is a weighted sum of a bid times expected click-through rate.

7. The method of claim 4 further comprising determining a number of content items to be included in each group based at least in part on an amount of space on the resource that is allocated to present responsive content items.

8. The method of claim 4 further comprising determining a number of groups to be presented on the resource responsive to the request based at least in part on an amount of space on the resource that is allocated to present responsive content items.

9. The method of claim 1 further comprising determining that a single content sponsor is associated with two content items in a same group, and wherein determining a second bounding price includes determining a second bounding price for a first content item associated with the single content sponsor as equal to an allocated portion of a sum of values associated with each content item in the group that are associated with the single content sponsor.

10. The method of claim 9 wherein the allocation is selected from the group comprising a weighted allocation based on one or more criteria or an equal allocation.

11. The method of claim 10 wherein the weighting is based on a ranking in the group.

12. The method of claim 9 wherein the value is a value used in determining how much to price a respective content item in order for a group associated with the content item to be maintained in a current position in a ranking of groups of content items.

13. The method of claim 1 further comprising determining that a single content sponsor is associated with two different content items that are included in two different groups, and wherein determining a second bounding price includes determining a second bounding price for a first content item associated with the single content sponsor using a second price bid associated with a second content item associated with the single content sponsor.

14. The method of claim 1 wherein the value is a bid amount.

15. A computer program product embodied in a non-transitive computer-readable medium including instructions, that when executed, cause one or more processors to:
receive a request for content for publication on a resource;
identify a plurality of content items that are responsive to the request, including identifying a plurality of groups of content items;
conduct an auction to identify content to provide responsive to the request, including identifying at least a first group and a second group of content items wherein each group includes plural content items;
determine a price to charge sponsors associated with each content item in each group, including for each content item in a group:
determine a first bounding price that is a second price auction value for a respective individual content item in a respective group;
determine a second bounding price that is a price that reflects a value that must be maintained for the respective individual content item in order to keep the respective group in a same position in a ranking of the groups; and
determine a final price that is equal to a greater of the first and second bounding prices; and
charge a sponsor associated with a respective content item the determined final price.

16. The computer program product of claim 15 further comprising instructions to determine that a single content sponsor is associated with two content items in a same group, and wherein determining a second bounding price includes determining a second bounding price for a first content item associated with the single content sponsor as equal to an allocated portion of a sum of values associated with each content item in the group that are associated with the single content sponsor.

17. The computer program product of claim 15 further comprising instructions to determine that a single content sponsor is associated with two different content items that are included in two different groups, and wherein determining a second bounding price includes determining a second bounding price for a first content item associated with the single content sponsor using a second price bid associated with a second content item associated with the single content sponsor.

18. A system comprising:
one or more processors; and
one or more memory elements including instructions that, when executed, cause the one or more processors to:
receive a request for content for publication on a resource;
identify a plurality of content items that are responsive to the request, including identifying a plurality of groups of content items;
conduct an auction to identify content to provide responsive to the request, including identifying at least a first group and a second group of content items wherein each group includes plural content items;
determine a price to charge sponsors associated with each content item in each group, including for each content item in a group:
determine a first bounding price that is a second price auction value for a respective individual content item in a respective group;
determine a second bounding price that is a price that reflects a value that must be maintained for the respective individual content item in order to keep the respective group in a same position in a ranking of the groups; and
determine a final price that is equal to a greater of the first and second bounding prices; and
charge a sponsor associated with a respective content item the determined final price.

19. The system of claim 18 further comprising instructions to determine that a single content sponsor is associated with two content items in a same group, and wherein determining a second bounding price includes determining a second bounding price for a first content item associated with the single content sponsor as equal to an allocated portion of a sum of values associated with each content item in the group that are associated with the single content sponsor.

20. The system of claim 18 further comprising instructions to determine that a single content sponsor is associated with two different content items that are included in two different groups, and wherein determining a second bounding price includes determining a second bounding price for a first content item associated with the single content sponsor using a second price bid associated with a second content item associated with the single content sponsor.
